(19) United States
(12) Patent Application Publication
(10) Pub. No.: US 2014/0292196 A1
(43) Pub. Date: Oct. 2, 2014

(54) THIN PROFILE ELECTRONIC BALLAST AND FABRICATING METHOD THEREOF

(71) Applicant: DELTA ELECTRONICS, INC., Taoyuan Hsien (TW)

(72) Inventor: Ching-Ho Chou, Taoyuan Hsien (TW)

(73) Assignee: DELTA ELECTRONICS, INC., Taoyuan Hsien (TW)

(21) Appl. No.: 14/029,401

(22) Filed: Sep. 17, 2013

(30) Foreign Application Priority Data
Mar. 27, 2013 (TW) 102110972

(51) Int. Cl. F21V 23/02

(52) U.S. Cl. CPC F21V 23/026
USPC 315/51; 29/829

(57) ABSTRACT

A thin profile electronic ballast for a lighting device includes a metal casing, a circuit board, and a metal cover. The metal casing includes an entrance and a receptacle. The circuit board includes a plurality of electronic components. The circuit board is accommodated within the receptacle of the metal casing. The entrance of the metal casing is covered by the metal cover. The circuit board is disposed in a direction vertical to the metal cover.

### FIELD OF THE INVENTION

The present invention relates to an electronic ballast, and more particularly to a thin profile electronic ballast. The present invention also relates to a method of fabricating the thin profile electronic ballast in a simplified and cost-effective manner.

### BACKGROUND OF THE INVENTION

An electronic ballast is usually used to provide a start voltage to a lighting device and provide a stable current to maintain the lighting stability. As known, the product yield of the electronic ballast is an important factor influencing the performance of the lighting device. With the increasing development of science and technology, the manufacturers of electronic devices make efforts in designing novel products. For example, the trends of designing the lighting devices are toward light weightiness, slimness and miniaturization. If the lighting device meets the requirements of light weightiness, slimness and miniaturization, the flexibility of installing the lighting device will be enhanced and the competiveness thereof is increased. For reducing the volume of the lighting device, the manufacturers pay much attention to the reduction of the electronic ballast.

Generally, the height of the conventional inductor-type electronic ballast is about 1.6 inch. The height of the electronic ballast is dependent on the height of the electronic components that are mounted on a circuit board of the electronic ballast. The electronic components include for example a transformer, an inductor, a capacitor, a transistor, and so on. Alternatively, the electronic ballast may even contain a heat sink. For providing a required voltage and a stable current to the lighting device, the electronic components of the electronic ballast are correspondingly varied according to the practical requirements. Since these electronic components occupy the space of the electronic ballast, the overall volume of the electronic ballast is influenced by these electronic components. Conventionally, a method of reducing the volume of the electronic ballast by reducing the height of the hand insert component has been disclosed. Alternatively, as shown in FIG. 1, another method of reducing the volume of the electronic ballast is performed by installing the taller electronic component (e.g. the capacitor 10) on a circuit board 11 in a horizontal arrangement. Since the taller electronic component is in the horizontal arrangement, the overall height of the electronic ballast may be correspondingly reduced. However, the way of mounting the taller electronic component in the horizontal arrangement still has some drawbacks. For example, since the electronic component to be horizontally mounted on the circuit board should be specially designed, the fabricating cost of the electronic ballast is increased. Moreover, although the overall height of the electronic ballast is reduced, the electronic component in the horizontal arrangement may occupy much space of the electronic ballast. Under this circumstance, the available area of the circuit board 11 is correspondingly reduced. Moreover, since the capacitor 10 is mounted on the circuit board 11 in the horizontal arrangement, the pins 100 of the capacitor 10 should be bent downwardly. As known, the process of bending the pins 100 may increase the possibility of causing damage, poor contact or short-circuit of the pins 100. Moreover, a method of increasing the available area of the circuit board 11 by installing the electronic components on both surfaces of the circuit board 11 has been disclosed. However, the fabricating cost of this method is largely increased.

Recently, an electronic ballast with a low-profile vertical transformer is disclosed. The use of the low-profile vertical transformer can reduce the overall height of the electronic ballast. However, the interaction between the leakage inductance of the low-profile vertical transformer and the conductive casing of the electronic ballast may result in eddy current loss. For reducing the eddy current loss, an insulator should be additionally installed between the magnetic core of the transformer and the circuit board. Under this circumstance, the process of fabricating the electronic ballast becomes more complicated, and the fabricating cost is increased.

FIG. 2 is a schematic exploded view illustrating another conventional electronic ballast. As shown in FIG. 2, the electronic ballast 2 comprises an upper cover 20, a circuit board 21, an insulator 22, and a metal casing 23. Moreover, a plurality of electronic components 24 are mounted on the circuit board 21. During the circuit board 21 is introduced into the metal casing 23, the circuit board 21 should be pressed down in order to effectively reduce the overall height of the electronic ballast 2. As the circuit board 21 is pressed down, the pins (not shown) of the electronic components 24 that are penetrated through the bottom surface of the circuit board 21 may pierce through the insulator 22 and contact with the metal casing 23. For preventing from the direct contact between the electronic components 24 and the metal casing 23, a first glue-pouring process is performed to apply an insulating glue on the inner surface of the metal casing 23, and then the insulator 22 and the circuit board 21 are sequentially accommodated within the metal casing 23. Then, a second glue-pouring process is performed to fill the insulating glue into the space between the circuit board 21 and the insulator 22. After the upper cover 20 is combined with the metal casing 23, the electronic ballast 2 is assembled. Since at least two glue-pouring processes are needed, the method of fabricating the electronic ballast 2 is very complicated.

Therefore, there is a need of providing a thin profile electronic ballast by using a simplified fabricating method.

### SUMMARY OF THE INVENTION

The present invention provides a thin profile electronic ballast with a reduced overall height.

The present invention also provides a thin profile electronic ballast. The general or modularized electronic components may be mounted on the circuit board of thin profile electronic ballast, and it is not necessary to specially design the electronic components, so that the fabricating cost will be largely reduced.

The present invention further provides a method of fabricating a thin profile electronic ballast by using a single glue-pouring process in order to produce the thin profile electronic ballast in a simplified, cost-effective and time-saving manner.

In accordance with an aspect of the present invention, there is provided a thin profile electronic ballast for a lighting device. The thin profile electronic ballast includes a metal casing, a circuit board, and a metal cover. The metal casing includes an entrance and a receptacle. The circuit board includes a plurality of electronic components. The circuit board is accommodated within the receptacle of the metal casing. The entrance of the metal casing is covered by the metal cover. The circuit board is disposed in a direction vertical to the metal cover.

In accordance with another aspect of the present invention, there is provided a method of fabricating a thin profile electronic ballast. Firstly, a metal casing is provided. The metal casing includes an entrance and a receptacle. Then, a circuit board with a plurality of electronic components is introduced into the receptacle of the metal casing through the entrance, wherein the circuit board is disposed in a direction vertical to the entrance. Then, a metal cover is provided to cover the entrance of the metal casing.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a capacitor and a circuit board of a conventional electronic ballast, in which the capacitor is mounted on the circuit board in a horizontal arrangement;

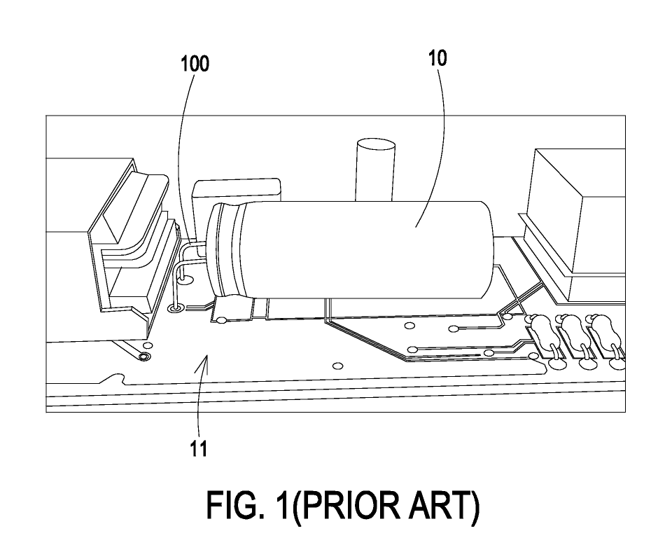

FIG. 2 is a schematic exploded view illustrating another conventional electronic ballast;

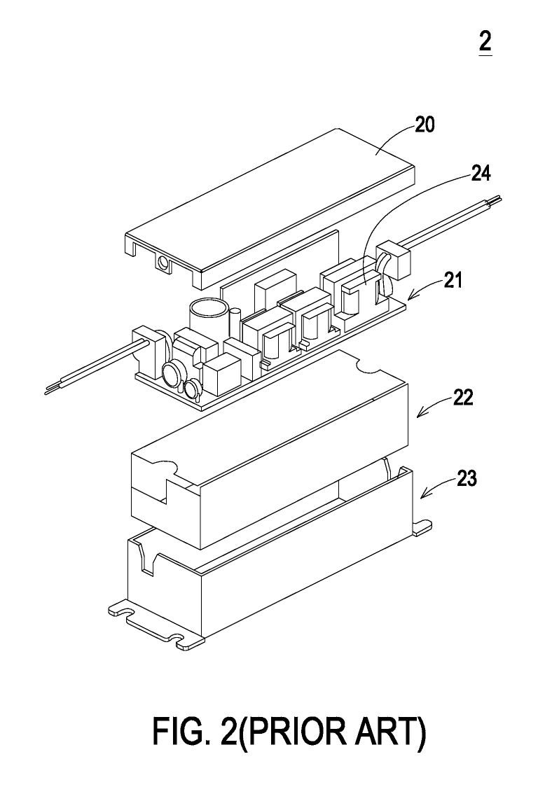

FIG. 3 is a schematic exploded view illustrating a thin profile electronic ballast according to an embodiment of the present invention;

FIG. 4 is a schematic top view illustrating the thin profile electronic ballast of FIG. 3; and

FIG. 5 is a flowchart illustrating a method of fabricating a thin profile electronic ballast according to an embodiment of present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

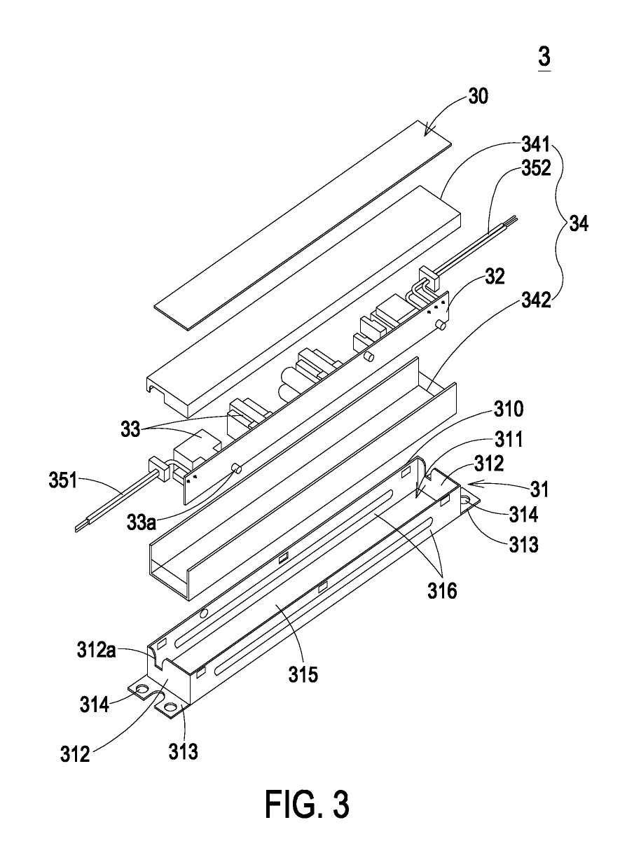

FIG. 3 is a schematic exploded view illustrating a thin profile electronic ballast according to an embodiment of the present invention. As shown in FIG. 3, the thin profile electronic ballast 3 comprises a metal casing 31, a circuit board 32, and a metal cover 30. The metal casing 31 includes an entrance 310 and a receptacle 311. The entrance 310 is in communication with the receptacle 311. In an embodiment, the metal casing 31 comprises two short lateral plates 312, two long lateral plates 316 and a bottom plate 315, and the entrance 310 and the receptacle 311 are defined by the two short lateral plates 312, the two long lateral plates 316 and the bottom plate 315 collaboratively. Moreover, a plurality of electronic components 33 are mounted on the circuit board 32. The circuit board 32 and the electronic components 33 are accommodated within the receptacle 311 of the metal casing 31, and the circuit board 32 is disposed in a direction vertical to the entrance 310. Namely, the circuit board 32 is in parallel with the long lateral plates 316 and is vertical to the bottom plate 315. After the entrance 310 of the metal casing 31 is covered by the metal cover 30, the circuit board 32 is disposed in a direction vertical to the metal cover 30 and the thin profile electronic ballast 3 is assembled.

In some other embodiments, the thin profile electronic ballast 3 further comprises an insulator 34. As shown in FIG. 3, the insulator 34 comprises an insulating cover 341 and an insulating casing 342. The insulator 34 is arranged between the circuit board 32 and the combination of the metal casing 31 and metal cover 30 for isolating the circuit board 32 from the metal casing 31 and metal cover 30. Namely, the insulating cover 341 is arranged between the circuit board 32 and the metal cover 30 for isolating the circuit board 32 from the metal cover 30, and the insulating casing 342 is arranged between the circuit board 32 and the metal casing 31 for isolating the circuit board 32 from the metal casing 31. In this embodiment, the insulator 34 may be a slim type insulating film. In addition, the insulator 34 may be made of any other insulating material.

In some embodiments, the thin profile electronic ballast 3 further comprises a dielectric media (not shown) disposed in the receptacle 311. Preferably, the dielectric media is made of the insulating glue, but it is not limited thereto. In an embodiment, a glue-pouring process may be performed to fill the insulating glue into the space between the circuit board 32 and the insulator 34. The use of the insulating glue can provide the fixing, moisture-proof, heat-dissipating and noise-reducing functions. An example of the dielectric media includes but is not limited to asphalt or viscous encapsulant. Alternatively, the dielectric media may be replaced by an insulating pad, which is made of an environment protection insulating material. The insulating pad is arranged between the circuit board 32 and the insulator 34 for providing the fixing, insulating and noise-reducing functions. It is noted that the material of the dielectric media may be varied according to the practical requirements.

Please refer to FIG. 3 again. The thin profile electronic ballast 3 further comprises an input wire 351 and an output wire 352. The input wire 351 and the output wire 352 are electrically connected with the circuit board 32 for inputting electric power and outputting electric power, respectively. In this embodiment, the metal casing 31 has a rectangular hollow box profile, but is not limited thereto. Namely, the metal casing 31 comprises two short lateral plates 312 opposite to each other, two long lateral plates 316 opposite to each other and a bottom plate 315, and the entrance 310 and the receptacle 311 are defined by the two short lateral plates 312, the two long lateral plates 316 and the bottom plate 315 collaboratively. Moreover, each of the two short lateral plates 312 of the metal casing 31 has a notch 312a (i.e. a first notch and a second notch). The input wire 351 and the output wire 352 are penetrated through the two notches 312a, respectively (i.e. the input wire 351 and the output wire 352 are penetrated through the first notch and the second notch, respectively). Moreover, two extension parts 313 are horizontally extended from the junctions between the two short lateral plates 312 and the bottom plate 315, respectively. The extension part 313 has plural perforations 314. By tightening screws (not shown) into corresponding perforations 314, the thin profile electronic ballast 3 can be fixed on a lighting device (not shown).

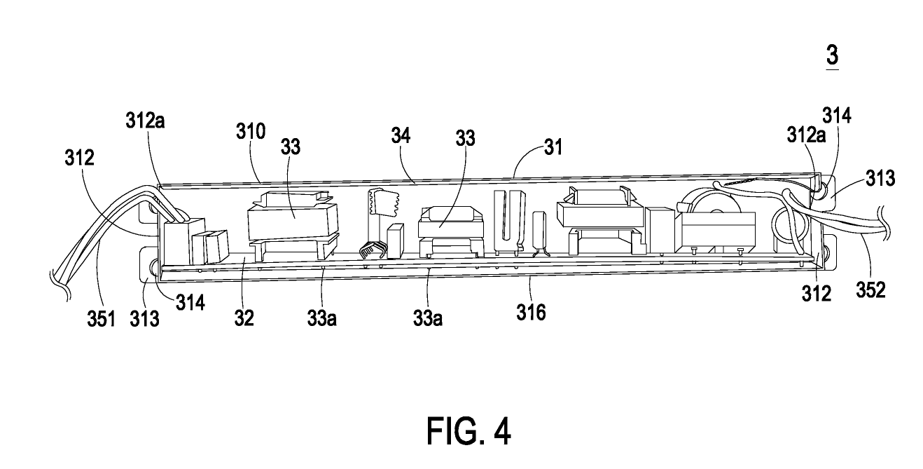

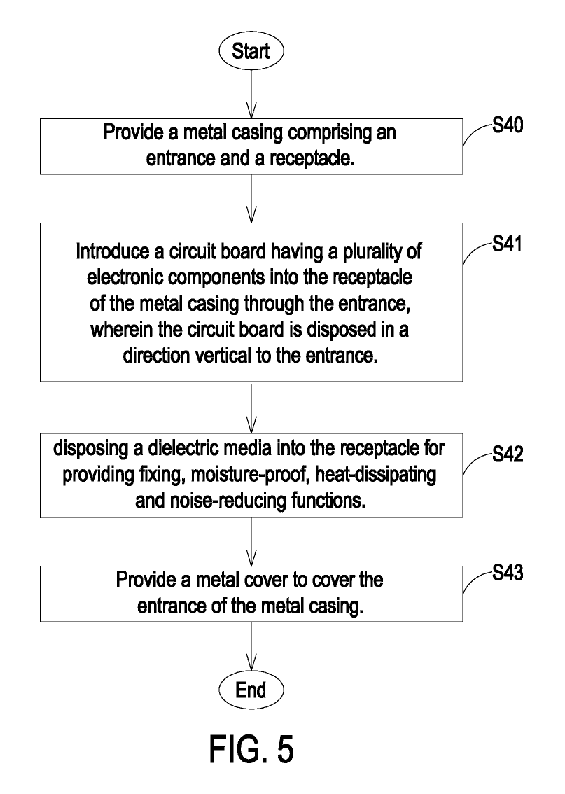

FIG. 4 is a schematic top view illustrating the thin profile electronic ballast of FIG. 3. FIG. 5 is a flowchart illustrating a method of fabricating a thin profile electronic ballast according to an embodiment of present invention. Please refer to FIGS. 3, 4 and 5. The method of fabricating the thin profile electronic ballast 3 includes the following steps. Firstly, in the step S40, a metal casing 31 is provided. The metal casing 31 comprises an entrance 310 and a receptacle 311. In an embodiment, the metal casing 31 comprises two short lateral plates 312, two long lateral plates 316 and a bottom plate 315, and the entrance 310 and the receptacle 311 are defined by the two short lateral plates 312, the two long lateral plates 316 and the bottom plate 315 collaboratively.

Optionally, after the step S40, an insulator 34 is provided and accommodated within the receptacle 311 of the metal casing 31 for isolation. In an embodiment, an insulating casing 342 of the insulator 34 is provided and accommodated within the receptacle 311 of the metal casing 31 and arranged between the circuit board 32 and the metal casing 31.

Then, in the step S41, a circuit board 32 with a plurality of electronic components 33 are introduced into the receptacle 311 of the metal casing 31 through the entrance 310 and disposed in a direction vertical to the entrance 310. Namely, the circuit board 32 is in parallel with the long lateral plate 316. After the circuit board 32 is accommodated within the receptacle 311 of the metal casing 31, the circuit board 32 is uprightly disposed within the metal casing 31. Under this circumstance, the space utilization of the circuit board 32 is enhanced. Consequently, the general or modularized electronic components complying with the general specifications can be used as the plural electronic components 33 of the present invention. Since it is not necessary to specially design the electronic components 33, the designing and fabricating cost will be reduced. Examples of the plural electronic components 33 include but are not limited to transformers, inductors, capacitors or transistors.

Then, in the step S42, a dielectric media (not shown) is disposed in the receptacle 311 to provide the fixing, moisture-proof, heat-dissipating and noise-reducing functions. In an embodiment, the dielectric media is made of insulating glue and disposed between the insulator 34 and the circuit board 32. Preferably, a glue-pouring process is performed to fill the insulating glue into the receptacle 311 and disposed between the insulator 34 and the circuit board 32. Since the circuit board 32 is uprightly disposed within the metal casing 31 (i.e. the circuit board 32 is disposed in a direction vertical to the entrance 310), the pins 33a of the electronic components 33 penetrating through the circuit board 32 may face the long lateral plate 316, which is adjacent to and disposed between the two short lateral plates 312 (see FIG. 4). Moreover, since it is not necessary to press down the circuit board 32, each pin 33a and the long lateral plate 316 are separated from each other by a gap. After the insulating glue is filled into the gap, the circuit board 32 is isolated from the metal casing 31. Moreover, in case that the insulating casing 342 is arranged between the circuit board 32 and the long lateral plate 316 of the metal casing 31, the possibility of piercing through the insulating casing 342 of the insulator 34 by the pins 33a will be minimized because it is not necessary to press down the circuit board 32. In other words, the single glue-pouring process can effectively and completely encapsulate the insulating glue around the circuit board 32 and the electronic components 33 and even the pins 33a in order to provide the fixing, moisture-proof, heat-dissipating and noise-reducing functions.

Optionally, after the step S42, an insulating cover 341 is disposed over the circuit board 32 and the insulating glue for isolation.

Afterwards, in the step S43, the entrance 310 of the metal casing 31 is covered by a metal cover 30. Consequently, the thin profile electronic ballast 3 is assembled.

From the above descriptions, the present invention provides a thin profile electronic ballast and a fabricating method thereof. The thin profile electronic ballast comprises a metal casing, a circuit board, and a metal cover. Since the circuit board is disposed in a direction vertical to the entrance of the metal casing (i.e. the circuit board is disposed in a direction vertical to the metal cover, or the circuit board is in parallel with a long lateral plate of the metal casing), the overall height of the thin profile electronic ballast can be largely reduced. Under this circumstance, since the general or modularized electronic components may be mounted on the circuit board and it is not necessary to specially design the electronic components, the fabricating cost will be largely reduced. Moreover, since only a single glue-pouring process is used to encapsulate the circuit board, the fabricating method of the thin profile electronic ballast is simplified and more time-saving.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A thin profile electronic ballast for a lighting device, said thin profile electronic ballast comprising:
a metal casing comprising an entrance and a receptacle;
a circuit board with a plurality of electronic components, wherein said circuit board is accommodated within said receptacle of said metal casing; and
a metal cover for covering said entrance of said metal casing, wherein said circuit board is disposed in a direction vertical to said metal cover.

2. The thin profile electronic ballast according to claim 1, further comprising an insulator, wherein said insulator is arranged between said circuit board and the combination of said metal casing and said metal cover for isolation.

3. The thin profile electronic ballast according to claim 2, further comprising a dielectric media disposed in said receptacle and arranged between said circuit board and said insulator.

4. The thin profile electronic ballast according to claim 3, wherein said dielectric media is an insulating glue for providing fixing, moisture-proof, heat-dissipating and noise-reducing functions.

5. The thin profile electronic ballast according to claim 1, further comprising an input wire and an output wire, wherein said input wire and said output wire are electrically connected with said circuit board.

6. The thin profile electronic ballast according to claim 5, wherein said metal casing further comprises two short lateral plates opposite to each other, wherein each of said two short lateral plates has a notch, wherein said input wire and said output wire are penetrated through said notches of said two short lateral plates.

7. The thin profile electronic ballast according to claim 1, wherein said electronic components are modularized electronic components and comprise transformers, capacitors or transistors.

8. The thin profile electronic ballast according to claim 1, said metal casing comprises two short lateral plates, two long lateral plates and a bottom plate, and said entrance and said receptacle are defined by said two short lateral plates, said two long lateral plates and said bottom plate, wherein said circuit board is in parallel with said long lateral plates.

9. A method of fabricating a thin profile electronic ballast, said method comprising steps of:
(a) providing a metal casing, wherein said metal casing comprises an entrance and a receptacle;
(b) introducing a circuit board with a plurality of electronic components into said receptacle of said metal casing through said entrance, wherein said circuit board is disposed in a direction vertical to the entrance; and
(c) providing a metal cover to cover said entrance of said metal casing.

10. The method according to claim 9, wherein after said step (a), said method further comprises a step (a1) of: disposing an insulator into said receptacle for isolation.

11. The method according to claim 10, wherein after said step (b), said method further comprises a step (b1) of: disposing a dielectric media in said receptacle and arranged between said circuit board and said insulator.

12. The method according to claim 11, wherein said dielectric media is made of an insulating glue, and a glue-pouring process is performed to fill said insulating glue into a space between said circuit board and said insulator.

13. The method according to claim 9, wherein said metal casing further comprises two short lateral plates opposite to each other, wherein each of said two short lateral plates has a notch, wherein an input wire and an output wire are both electrically connected with said circuit board, and said input wire and said output wire are penetrated through said notches of said two short lateral plates.

14. The method according to claim 9, wherein said metal casing comprises two short lateral plates, two long lateral plates and a bottom plate, and said entrance and said receptacle are defined by said two short lateral plates, said two long lateral plates and said bottom plate, wherein said circuit board is in parallel with said long lateral plates.
